(19) United States
(12) Patent Application Publication
(10) Pub. No.: US 2023/0187690 A1
(43) Pub. Date: Jun. 15, 2023

(54) METHOD OF MAKING ELECTRODES FOR ALL SOLID STATE BATTERIES

(71) Applicant: HYZON MOTORS INC., Honeoye Falls, NY (US)

(72) Inventors: Rajesh Bashyam, Delta (CA); Zhijun Gu, Naperville, IL (US)

(21) Appl. No.: 18/081,183

(22) Filed: Dec. 14, 2022

Related U.S. Application Data
(60) Provisional application No. 63/289,507, filed on Dec. 14, 2021.

(51) Int. Cl. H01M 10/0562; H01M 10/0567

(52) U.S. Cl. CPC H01M 10/0562; H01M 10/0567; H01M 2004/022

(57) ABSTRACT

Methods of making a lithiated composite fiber include mixing lithiated perfluorosulfonic acid with a suitable polymer to form a polymer solution and electrospinning the polymer solution to generate a lithiated fiber. The lithiated fiber can be used to make positive electrodes. Methods of making a positive electrode with lithiated fiber include mixing an active material, lithiated fiber, an electrically conductive additive, and a solvent to form a solution and processing the solution. The processed solution can be coated on an aluminum sheet.

### CROSS-REFERENCE TO RELATED APPLICATIONS

This application claims the benefit of U.S. Provisional Application No. 63/289,507, filed on Dec. 14, 2021. The entire disclosure of the above application is hereby incorporated herein by reference.

### FIELD

The present technology includes processes and articles of manufacture that relate to solid-state lithium-ion batteries, including fiber-containing electrodes and electrode-electrolyte composites for all solid-state batteries.

### INTRODUCTION

This section provides background information related to the present disclosure which is not necessarily prior art.

All solid-state batteries are gaining significant attention in lithium-ion battery development due to several advantages, including consistent operation, high energy density, and faster charging properties. However, certain challenges remain to be overcome, especially with respect to solid-state electrolytes, in order to improve conductivity and suppress formation of lithium dendrites. Two main approaches are being employed to develop solid electrolytes, the first being the use inorganic ceramic solid electrolytes and the second being use of a solid polymer electrolyte, where both approaches have their own advantages and disadvantages.

Advantages of all solid-state lithium-ion batteries include high energy density and safety. However, while expectations for solid-state batteries are high, there are still issues related to materials, processing, and engineering to overcome. Certain types and applications of batteries can require dimensions and configurations that can be difficult to process, handle, and manipulate during manufacture, which can also present issues during use of the assembled battery. Batteries can be subjected to environments that can experience particular shocks related to physical forces as well as varying temperatures, where it may be optimal to design a battery that can provide a predetermined performance throughout a wide range of operating conditions. Durability and stability of electrode and electrolyte components of the battery are hence important considerations in manufacture and performance of the assembled battery.

Accordingly, there is a need for an electrode-electrolyte composite having improved durability and stability for solid-state lithium-ion battery applications. The electrode-electrolyte composite should optimize cathode electrode design and processing, provide improved performance with respect to speed and scale of battery manufacture, and increase operational integrity of the battery.

### SUMMARY

In concordance with the instant disclosure, ways to maximize durability and stability of all solid-state lithium-ion batteries that further address challenges associated with cathode electrode design and processing, are surprisingly discovered.

Ways are provided for making and using a fiber-containing electrode for a solid-state lithium battery. A process for manufacture of the fiber-containing electrode can include forming an electrode composition, where the electrode composition includes a lithiated ionomer, a carrier polymer, and a polar solvent. Electrospinning the electrode composition results in a lithiated fiber. A layer including the lithiated fiber is formed to provide the fiber-containing electrode for the solid-state lithium battery.

An electrode-electrolyte composite for a solid-state lithium battery can be formed by making the fiber-containing electrode and disposing the fiber-containing electrode in direct contact with a solid-state electrolyte. Disposing the fiber-containing electrode in direct contact with the solid-state electrolyte can include transferring the fiber-containing electrode from a substrate to the solid-state electrolyte. Disposing the fiber-containing electrode in direct contact with the solid-state electrolyte can also include forming one of the solid-state electrolyte and the fiber-containing electrode directly on the other one of the solid-state electrolyte and the fiber-containing electrode. Various fiber-containing electrodes and electrode-electrolyte composites can be made using the present technology. These can be incorporated into solid-state lithium-ion batteries, including systems and articles of manufacture using such batteries, including vehicle applications.

In certain embodiments, methods of making lithiated fibers include mixing lithiated perfluorosulfonic acid with a suitable polymer to form a polymer solution and electrospinning the polymer solution to generate lithiated fibers. The lithiated fibers can comprise a diameter from submicron to one hundred microns. Alternatively, the lithiated fibers can comprise a diameter from submicron to ten microns. The lithiated fiber length can be controlled during electrospinning. Alternatively, in some embodiments, the lithiated fiber length is determined by various post-formation operations, including shearing, comminuting, milling, and triturating operations.

In certain embodiments, methods of making a positive electrode with lithiated fibers include mixing an active material, lithiated fibers, an electrically conductive additive, and a solvent to form a solution, processing the solution using shear mixing and coating the processed solution on an aluminum sheet. The lithiated fiber can be formed by mixing lithiated perfluoro sulphonic acid with a suitable polymer to form a polymer solution, which can be subjected to electrospinning to generate lithiated fibers. The composition of the lithiated fibers within the solution can be between 3% and 35%. Alternatively, the composition of the lithiated fiber within the solution can be between 5% and 25%. The processed solution can be coated on the aluminum sheet using various processes, including use of a slot-die or doctor blade, as well as micro gravure methods.

Various solid-state electrode and electrolytes can be made according to the present technology. Such electrode-electrolyte composites can be incorporated into all solid-state lithium-ion batteries. Likewise, various batteries, including multicell batteries, can be manufactured using one or more of the electrode-electrolyte composites. Certain applications include vehicles using a solid-state lithium-ion battery that incorporates one or more electrode-electrolyte composites made in accordance with the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic flowchart of a first method of making a fiber-containing electrode for a solid-state lithium-ion battery, in accordance with the present technology;

FIG. 2 is a schematic flowchart of a second method of making a fiber-containing electrode for a solid-state lithium-ion battery, in accordance with the present technology; and

FIG. 3 is a schematic cross-sectional design of an embodiment of a solid-state lithium-ion battery including a fiber-containing electrode, in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to ways of making and using a fiber-containing electrode for a solid-state lithium-ion battery that maximize lithium-ion transport and conductivity. Methods and articles of manufacture formed using the subject methods provide a fiber-containing electrode that can be used with a solid-state electrolyte in assembly and manufacture of various solid-state lithium-ion batteries. The fiber-containing electrode serves to optimize cathode electrode design and processing and provides improved performance with respect to speed and scale of battery manufacture.

In certain embodiments, a method of making a fiber-containing electrode for a solid-state lithium battery can include forming an electrode composition, where the electrode composition includes a lithiated ionomer, a carrier polymer, and a polar solvent. Electrospinning the electrode composition can consequently form a lithiated fiber. Forming a layer including the lithiated fiber can thereby provide the fiber-containing electrode for the solid-state lithium battery.

The lithiated ionomer can include the following aspects. The lithiated ionomer can include a lithiated perfluorosulfonic acid. The lithiated perfluorosulfonic acid can have an equivalent weight (EW) of 300 to 1100. The lithiated perfluorosulfonic acid can include one or more of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The carrier polymer can include the following aspects. The carrier polymer can include a polyalkyene oxide, polyalkyene oxide block polymers, a vinyl polymer, and/or polyvinyl block polymers. Particular examples of the carrier polymer include one or more of polyethylene oxide, polyacrylonitrile, polyvinylidene fluoride, and polyvinyl alcohol.

The polar solvent can include the following aspects. The polar solvent can include various aqueous solutions, polar aprotic solvents, and protic solvents, including various alcohols and alcohol:water solutions. Examples of the polar solvent include one or more of methanol, n-propanol, isopropanol, and water.

In certain embodiments, the electrode composition can further include the following aspects. The electrode composition can include a cathode active material, where the cathode active material can include one of a metal oxide and a metal phosphate. Where the cathode active material includes the metal oxide, the metal oxide can include one or more of cobalt oxide, iron oxide, manganese oxide, and nickel oxide. Where the cathode active material includes the metal phosphate, the metal phosphate can include one or more of cobalt phosphate, iron phosphate, manganese phosphate, and nickel phosphate. The electrode composition can include an electrically conductive additive, where the electrically conductive additive can include various carbon species. Examples include where the electrically conductive additive includes one or more of carbon, carbon black, carbon microfibers, carbon nanofibers, carbon nanotubes, graphite nanofibers, and graphene. In certain embodiments, the electrically conductive additive can include Super P™, a structured carbon black powder with a moderate surface area, available from Imerys S.A. (Paris, France). Embodiments include where the electrode composition can further include both the cathode active material and the electrically conductive additive.

Electrospinning the electrode composition can include various methods that employ an electric force to draw charged threads of a polymer solution (e.g., the electrode composition) through a nozzle or spinneret to a collector plate. The resulting fibers can have various diameters, on the order of nanometers to micrometers. The particular polymers employed (e.g., the lithiated ionomer, the carrier polymer, etc.), solution characteristics (e.g., the polar solvent, components concentrations, etc.), and any additives (e.g., cathode active material, electrically conductive material, etc.), along with electrospinning process parameters (e.g., electric potential, distance between capillary/needle and collector, ambient parameters, etc.) can be tailored to provide resultant fibers having desired or predetermined characteristics. For example, electrospinning the electrode composition can form a lithiated fiber having a diameter from 10 nanometers to 100 micrometers. In certain embodiments, the lithiated fiber can have a diameter from 0.1 micrometers to 10 micrometers. Such methods can include electrospinning the electrode composition onto a current collector. Examples of the current collector include various plates or layers of metal (e.g., aluminum), graphite, porous carbon, and graphite paper.

The lithiated fiber can be processed in various ways prior to forming the layer including the lithiated fiber to provide the fiber-containing electrode. Certain processes include fragmenting or breaking the lithiated fiber to form a population of lithiated fibers having a predetermined length. Processing the lithiated fiber to form lithiated fibers having a predetermined length can include subjecting the lithiated fiber to various forces, including mechanical and hydrodynamic forces. Example processes include shearing, comminuting, milling, and triturating operations. In this way, the resulting lithiated fibers can have a predetermined length, including where substantially all the lithiated fibers have the predetermined length or where the population of lithiated fibers provides an average predetermined length.

In certain embodiments, forming the layer including the lithiated fiber can include forming a layering composition including the lithiated fiber, a cathode active material, and an electrically conductive additive, where the layering composition is used in forming the layer. The layering composition can further include a solvent, where examples include one or more of N-methyl-2-pyrrolidone, water, and alcohol. It is possible to process the layering composition to form lithiated fibers having a predetermined length prior to using the layering composition in forming the layer. As described herein, such processing can include subjecting the layering composition (and the lithiated fiber therein) to various forces, including mechanical and hydrodynamic forces. Example processes include shearing, comminuting, milling, and triturating operations. In this way, the resulting lithiated fibers in the layering composition can have a predetermined length, including where substantially all the lithiated fibers have the predetermined length or where the population of lithiated fibers provides an average predetermined length.

The layer including the lithiated fiber can include various aspects. In certain embodiments, the layer including the lithiated fiber can have 3-35 wt% lithiated fiber and 60-95 wt% cathode active material. Further examples include where the layer including the lithiated fiber have 5-25 wt% lithiated fiber.

Methods of making an electrode-electrolyte composite for a solid-state lithium battery are provided by the present technology, which can include making a fiber-containing electrode, as described herein, and disposing the fiber-containing electrode in direct contact with a solid-state electrolyte. Disposing the fiber-containing electrode in direct contact with the solid-state electrolyte can include transferring the fiber-containing electrode from a substrate to the solid-state electrolyte. Disposing the fiber-containing electrode in direct contact with the solid-state electrolyte can also include forming one of the solid-state electrolyte and the fiber-containing electrode directly on the other one of the solid-state electrolyte and the fiber-containing electrode. Various types of solid-state electrolytes can be used. For example, a fiber-containing electrode prepared in accordance with the present technology can be coupled with various solid-state electrolytes in construction of a solid-state lithium-ion battery. Examples of suitable solid-state electrolytes include the solid-state electrolytes, composite solid-state electrolytes, and reinforced solid-state electrolytes described in U.S. Pat. Application Publication No. 2022/0311044 A1 to Bashyam et al., published Sep. 29, 2022.

The solid-state electrolyte can be formed from an electrolyte composition. The electrolyte composition can include a lithiated perfluorosulfonic acid and a solvent. The electrolyte composition can be applied directly to the fiber-containing electrode. It is further possible to form the solid-state electrolyte and then bring one of the fiber-containing electrode and the solid-state electrolyte into direct contact with the other of the fiber-containing electrode and the solid-state electrolyte. The lithiated perfluorosulfonic acid of the electrolyte composition can have an equivalent weight (EW) of 300 to 1100 and can include one or more of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid. The solvent of the electrolyte composition can include one or more various organic solvents, including various alcohols, as well as various aprotic solvents, including various amines and cyclic amines. Particular examples of solvents include methanol, ethanol, n-propanol, isopropanol, N-methyl-2-pyrrolidone (NMP), and/or water.

Applying the electrolyte composition directly to the fiber-containing electrode can include the following aspects. Various types of apparatus and techniques can be selected based upon the nature of the fiber-containing electrode, considering dimensions as well as workflow. Application methodologies can include using a doctor blade, a micro gravure roller, as well as a slot die, for example. The solid-state electrolyte layer can be formed by applying the electrolyte composition directly to the fiber-containing electrode to provide various thicknesses, where certain embodiments include a thickness from 2 micrometers to 30 micrometers.

Fiber-containing electrodes made in accordance with the present methods can be incorporated into various articles of manufacture. For example, the fiber-containing electrode can be incorporated into a solid-state lithium-ion battery. Likewise, a vehicle can include a solid-state lithium-ion battery having a fiber-containing electrode made according to the methods provided herein.

In certain embodiments, the present technology provides ways of making lithiated composite fibers that can include lithiated perfluorosulfonic acid with an equivalent weight (EW) of 300 to 1100 comprising either short chain and its combinations, medium chain and its combinations, and long chain and its combinations, or other suitable combinations thereof. The lithiated perfluoro sulphonic acid can also comprise a mixture of short and long chain, a mixture of short and medium chain, and a mixture of medium and long chain band both or suitable combinations thereof. The lithiated perfluoro sulphonic acid is combined with a suitable career polymer such as polyethylene oxide, polyphthalamide (PPA), polyvinylidene fluoride (PVDF), polyvinyl alcohol (PVA), block polymers (PPO-PEO-PPO), and mixed polar solvents such as methanol, n-propyl alcohol or isopropyl alcohol. In certain cases, the solvents can also be mixtures of alcohol and water.

These polymer solutions can be electrospinned at a specific temperature, viscosity, flow rate, and voltage using commercial electrospinning equipment to generate the lithiated fibers. In certain embodiments, the generated lithiated fibers can comprise diameters from submicron to 100 microns. In certain embodiments, the diameter of the generated lithiated fibers comprise a diameter from submicron to 10 microns. However, diameter of the generated lithiated fibers can be tailored appropriately, as desired. In certain embodiments, the lithiated fibers are spun on aluminum or other appropriate collectors. For example, in certain embodiments the lithiated fibers are spun one one or more of a metal collector, a graphite collector, and a porous carbon/graphite paper collector. In certain embodiments, the lithiated fiber length can be controlled during electrospinning or can be determined by post processing methods.

In certain embodiments, positive electrode lithiated fibers can be produced using active materials such as lithium iron phosphate, lithium cobalt oxide, nickel manganese oxides, and other certain oxides free of nickel and cobalt in combination with a carbon additive such as Super P, carbon nanotubes (CNT) and the lithiated polymer solution with career polymer.

In a further example, a positive electrode is made with the lithiated fiber. The positive electrode can be made with an active material such as lithium iron phosphate or another oxide, such as described above, along with the lithiated fiber and an electronically conductive additive, such as Super P. In certain embodiments, the composition of the active material can be between 50% and 95% and the composition of the lithiated fiber can be between 1% and 50%. In further embodiments, the composition of the lithiated fiber can be between 3% and 35%. In still further embodiments, a composition of the lithiated fiber is between 5% and 25%. These materials can be mixed with solvents such as N-methyl-2-pyrrolidone (NMP), NMP/water, and an alcohol/water mixture. In certain embodiments, the above materials can be processed under different shear mixing and can be coated on an aluminum sheet using one or more of a slot-die, doctor blade, micro gravure and other appropriate coating process.

Various articles of manufacture can be produced in accordance with the present technology. The fiber-containing electrode made according to the present methods can be provided, including a resulting electrode-electrolyte composite including such. Various solid-state lithium-ion batteries can incorporate the fiber-containing electrode made according to the present methods. Likewise, various articles and systems employing solid-state lithium-ion batteries can use the present technology. A particular example includes a vehicle that includes a solid-state lithium-ion battery incorporating the fiber-containing electrode made as described herein.

The present technology can provide certain benefits and advantages in all solid-state lithium-ion batteries, including batteries used for various portable and mobility applications such as vehicles. Several issues with respect to lithium-ion batteries are addressed by the present technology, including increasing the lithium-ion transport and conductivity in the electrode while also addressing challenges associated with cathode electrode design and processing. Utilization of the fiber-containing electrode can increase the lithium transport rate due to the enhanced conductivity of the fiber and the ability to increase the thickness of the electrode, thereby increasing active material loading without a tradeoff in utilization. The fiber-containing electrode can further optimize cathode electrode design and processing, increasing durability and stability of the resulting electrode-electrolyte composite, permitting improved handling, and increasing speed and scale of battery manufacture.

### EXAMPLES

Example embodiments of the present technology are provided with reference to the figures enclosed herewith.

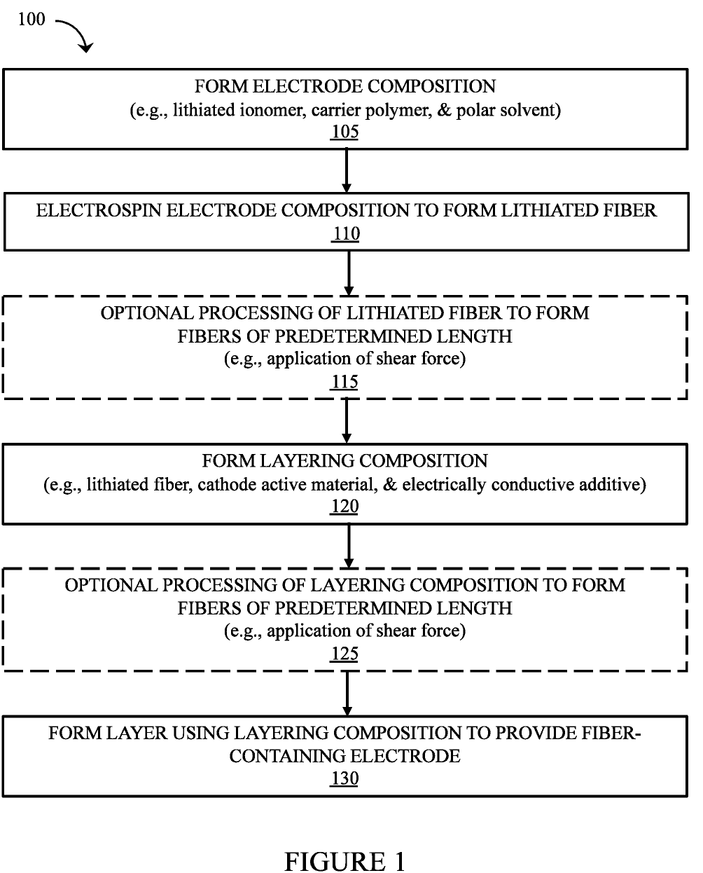

With reference to FIG. 1, a first embodiment of a method of making a fiber-containing electrode for a solid-state lithium-ion battery is shown at 100. At 105, an electrode composition can be formed, where the electrode composition can include a lithiated ionomer, a carrier polymer, and a polar solvent. At 110, the electrode composition can be subjected to electrospinning to form a lithiated fiber. At 115, the lithiated fiber can optionally be processed to form lithiated fibers having a predetermined length; e.g., a shear force can be applied to the lithiated fiber. At 120, a layering composition can be formed including the lithiated fiber (or optional lithiated fibers having a predetermined length), a cathode active material, and an electrically conductive additive. At 125, the layering composition can optionally be processed to form lithiated fibers having a predetermined length from the lithiated fiber (in addition to or if not already done at 115). At 130, a layer can be formed using the layering composition to provide the fiber-containing electrode for the solid-state lithium battery.

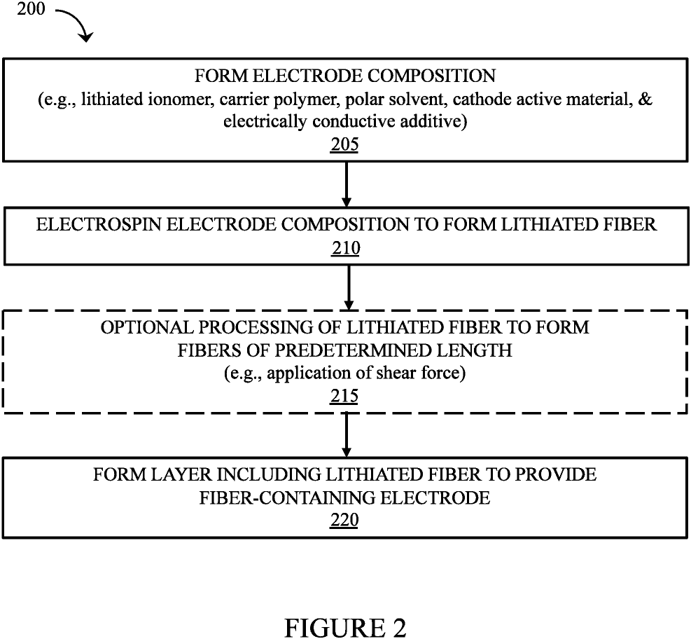

With reference to FIG. 2, a second embodiment of a method of making a fiber-containing electrode for a solid-state lithium-ion battery is shown at 200. At 205, an electrode composition can be formed, where the electrode composition can include a lithiated ionomer, a carrier polymer, a polar solvent, a cathode active material, and an electrically conductive additive. At 210, the electrode composition can be subjected to electrospinning to form a lithiated fiber. At 215, the lithiated fiber can optionally be processed to form lithiated fibers having a predetermined length; e.g., a shear force can be applied to the lithiated fiber. At 220, a layer is formed using the lithiated fiber to provide the fiber-containing electrode for the solid-state lithium battery. It is possible to include additional cathode active material and electrically conductive additive in forming the layer including the lithiated fiber to provide the fiber-containing electrode in step 220.

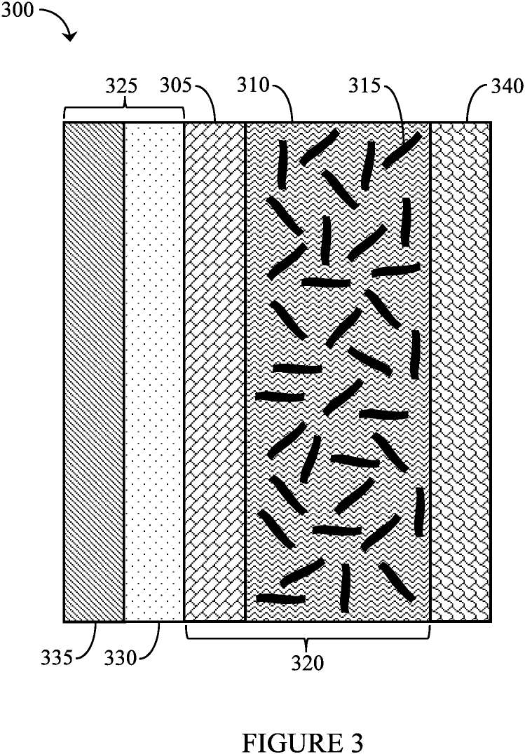

With reference to FIG. 3, a schematic cross-sectional design of an embodiment of a solid-state lithium-ion battery including a fiber-containing electrode is shown at 300. An electrolyte layer 305 is provided or formed as described herein. A fiber-containing electrode layer 310 is provided or formed as described herein, where an embodiment of a lithiated fiber having a predetermined size is depicted at 315. The electrolyte layer 305 and the fiber-containing electrode layer 310 can form an electrode-electrolyte composite 320. An anode layer 325 is disposed adjacent the electrolyte layer 305 of the electrode-electrolyte composite 320. The anode layer 325 can include a lithium layer 330 coated onto a copper layer 335. A metal layer 340 can be disposed adjacent the fiber-containing electrode layer 310 of the electrode-electrolyte composite 320. The metal layer 340 can include an aluminum layer, where the metal layer 340 can therefore function as a current collector.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a fiber-containing electrode for a solid-state lithium battery, comprising:
forming an electrode composition, the electrode composition including a lithiated ionomer, a carrier polymer, and a polar solvent;
electrospinning the electrode composition to form a lithiated fiber; and
forming a layer including the lithiated fiber, thereby providing the fiber-containing electrode for the solid-state lithium battery.

2. The method of claim 1, wherein the lithiated ionomer includes a lithiated perfluorosulfonic acid.

3. The method of claim 1, wherein the electrode composition further includes a cathode active material.

4. The method of claim 3, wherein the cathode active material includes one of a metal oxide and a metal phosphate.

5. The method of claim 1, wherein the electrode composition further includes an electrically conductive additive.

6. The method of claim 5, wherein the electrically conductive additive includes a member selected from a group consisting of carbon, carbon black, carbon microfibers, carbon nanofibers, carbon nanotubes, graphite nanofibers, and graphene.

7. The method of claim 1, wherein the electrode composition further includes a cathode active material and an electrically conductive additive.

8. The method of claim 1, wherein electrospinning the electrode composition to form the lithiated fiber includes forming a lithiated fiber having a diameter from 10 nanometers to 100 micrometers.

9. The method of claim 1, wherein electrospinning the electrode composition to form the lithiated fiber includes forming a lithiated fiber having a diameter from 0.1 micrometers to 10 micrometers.

10. The method of claim 1, further comprising processing the lithiated fiber to form lithiated fibers having a predetermined length prior to the layering composition being used in forming the layer.

11. The method of claim 1, wherein electrospinning the electrode composition to form the lithiated fiber includes electrospinning the electrode composition onto a current collector.

12. The method of claim 1, wherein forming the layer including the lithiated fiber includes forming a layering composition including the lithiated fiber, a cathode active material, and an electrically conductive additive, the layering composition being used in forming the layer.

13. The method of claim 12, further comprising processing the layering composition to form lithiated fibers having a predetermined length prior to the layering composition being used in forming the layer.

14. The method of claim 13, wherein processing the layering composition to form lithiated fibers having a predetermined length includes subjecting the layering composition to a shearing force.

15. The method of claim 1, wherein the layer including the lithiated fiber includes 3-35 wt% lithiated fiber and 60-95 wt% cathode active material.

16. The method of claim 1, wherein the layer including the lithiated fiber includes 5-25 wt% lithiated fiber.

17. A method of making an electrode-electrolyte composite for a solid-state lithium battery, comprising:
making a fiber-containing electrode according to the method of claim 1; and
disposing the fiber-containing electrode in direct contact with a solid-state electrolyte.

18. The method of claim 17, wherein disposing the fiber-containing electrode in direct contact with the solid-state electrolyte includes one of:
transferring the fiber-containing electrode from a substrate to the solid-state electrolyte; and
forming the solid-state electrolyte directly on the fiber-containing electrode.

19. A fiber-containing electrode for a solid-state lithium battery, the fiber-containing electrode made according to the method of claim 1.

20. A solid-state lithium-ion battery comprising a fiber-containing electrode made according to the method of claim 1.
